(19) United States
(12) Patent Application Publication
(10) Pub. No.: US 2008/0282167 A1
(43) Pub. Date: Nov. 13, 2008

(54) PRIVATE PRESENTER NOTES

(76) Inventor: Darin BEAMISH, Puyallup, WA (US)

Correspondence Address: DWC LAW FIRM, P.S., P.O. BOX 3041, SEATTLE, WA, 98114-3041, US

(21) Appl. No.: 12/099,070

(22) Filed: Apr. 7, 2008

Related U.S. Application Data
(60) Provisional application No. 60/910,634, filed on Apr. 6, 2007.

(51) Int. Cl. G06F 3/01

(52) U.S. Cl. 715/730; 715/751

(57) ABSTRACT

In some embodiments, a presenter remote unit, usable for controlling digital segments, such as digital presentation slides, has a display for displaying private notes that are pre-associated with the digital segments. The private notes can be navigated using a menu displayable on the presenter remote unit.

### CROSS-REFERENCE TO RELATED APPLICATION(S)

This application claims the benefit of U.S. provisional patent application Ser. No. 60/910,634 filed Apr. 6, 2007, which is incorporated herein by reference in its entirety.

### BACKGROUND OF THE INVENTION

1. Field of the Invention

The present invention relates to audience response systems, and more particularly, to wireless remote units for use by presenters in conducting multi-media presentations.

2. Description of Related Art

Electronic presentation systems are widely used. Examples of such systems include electronic projectors used in conjunction with presentation software, such as, for example, MICROSOFT POWERPOINT. As most people who have delivered electronic presentations to audiences know, these systems are efficient and effective, as evidenced by their popularity.

Often, these presentation systems are used with remote control units (having transmitters) that allow a presenter to walk about a room while controlling the presentation system, initiating changes in the slides, animation or sound. However, a dilemma for a presenter is that the presenter often has to refer to notes for speaking while conducting a presentation, even sometimes needing to return to a station, such as a podium. This impairs the flexibility of the electronic presentation system.

### BRIEF SUMMARY OF THE INVENTION

In some embodiments of the present invention, a compact handheld remote unit has a private display. The remote unit is wirelessly and communicatively linked to a computer which can be used to drive presentation media displayed during an audience presentation. The presentation media can be comprised of digital segments. As the digital segments are presented to an audience using one or more audience viewable displays, such as a projection screen, private presenter notes corresponding to each digital segment are displayed on the private display of the remote unit used by the presenter. Also, the presenter's remote unit can be used to control the presentation of digital segments, such as by, for example, having input members that can be depressed to toggle through, or control the presentation of, digital slides.

The private presenter notes presented on the presenter's remote unit can also include displaying a menu for use in selecting from a list of more detailed notes regarding particular topics related to a digital segment. The particular topics can include, without limitation, topics displayed on a digital slide, or any notable items or features presented on a digital slide.

Since some embodiments of the remote unit are compact for convenience of the presenter, the display of the private presenter notes is also compact and concise. That is, for example, the note menu is presentable so that the presenter can select a particular note, rather than having to view a whole page of notes which may not be readable on a small display device. Also, in some embodiments of the present invention, the note menu can be easily navigated and each detailed note selected for display on the private display by a presenter using only a single hand to select, or depress keys, on the remote unit. In this way, for some embodiments, the presenter can use the remote easily and effectively to toggle or control slides and view notes while having maximum flexibility to conduct other tasks, if necessary, with at least one hand.

### BRIEF DESCRIPTION OF SEVERAL VIEWS OF THE DRAWINGS

FIG. 1 is a diagram showing some major components of an embodiment of an audience response system having a projection device for use with the present invention.

FIGS. 2a & 2b are plan views of remote units for use with some embodiments of the present invention.

FIG. 2c is a simplified plan view of a remote unit for use with some embodiments of the present invention wherein the remote unit has an active digitizing surface for use with a pointer pen.

FIG. 3 is a simplified block diagram of an embodiment of the remote units of FIGS. 2a & 2b.

FIG. 4a is an example slide image projected for audience viewing, as described in EXAMPLE #1 for the present invention.

FIG. 4b is an example private slide header note, for EXAMPLE #1 of the present invention, as displayed on a remote unit used by a presenter.

FIG. 4c is an example compact note menu, for EXAMPLE #1 of the present invention, as displayed on a remote unit used by a presenter.

FIG. 4d is an example detailed note for EXAMPLE #1 of the present invention, as displayed on a remote unit used by a presenter.

FIG. 5 is a flow sheet for an embodiment of a process of the present invention.

FIG. 6 shows an example graphical user interface of the present invention for use in programming private presenter notes associated with digital segments in the form of slides and slide components.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available structures, hardware, software and wireless protocol have not been described in detail to avoid unnecessarily obscuring the descriptions of the embodiments of the invention.

The discussion below discloses, among other things, using the present invention in conjunction with a wireless audience response system in which the remote units have keypads and liquid crystal display devices (LCDs). However, as will be understood by one skilled in the art after reviewing this disclosure, various other contexts are contemplated. For example, a remote unit on which notes are displayed can have an active digitizing surface, as will be mentioned further below, wherein the proximity of a pen to a location on a digitizing surface can be sensed and used to provide an input to the remote unit. Also, a remote unit can be used alone by a presenter to deliver a presentation without collecting audience feedback electronically from audience remotes, or, alternatively, in an audience response system setting where audience feedback is being collected electronically from audience members, each having their own individual remote units.

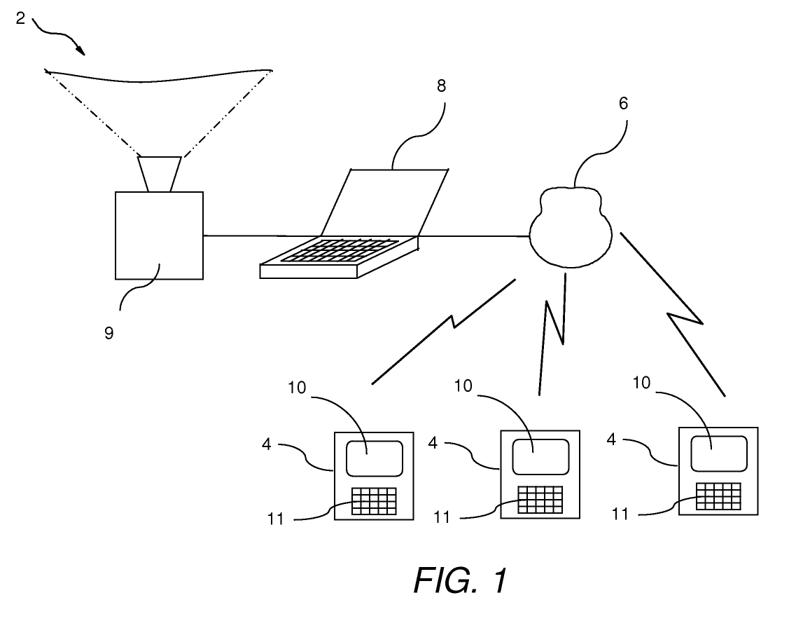

In some embodiments of the present invention an audience response system 2 is provided, having one or more remote units 4 and a host unit 6, as can be seen in FIG. 1. At least one of the remote units 4 can be configured for use by a presenter, which can have the same or similar structure as the other remote units 4, except that it may be pre-associated to have unique access rights to functions of the audience response system 2 not accessible to other users of remote units 4. The host unit 6 may be communicatively connected to a computer 8, including, for example, a laptop or desktop PC. Various audience response system software applications, and presentation software, can be used within the audience response system 2 using the computer 8. In addition, the computer 8 may be communicatively coupled to a projector 9, for use in projecting presentation media to a common screen shared by audience members.

A wireless communication link can be provided between the remote units 4 and the host unit 6 using, for example, infrared or radio frequency systems and related protocols, as will be appreciated by those skilled in the art after reviewing the present disclosure. For example, in some embodiments, wireless radio frequency (RF) communication is employed using an IEEE 802.15.4 compliant communications link with the host unit 6 and each of the remote units 4 having a transceiver module.

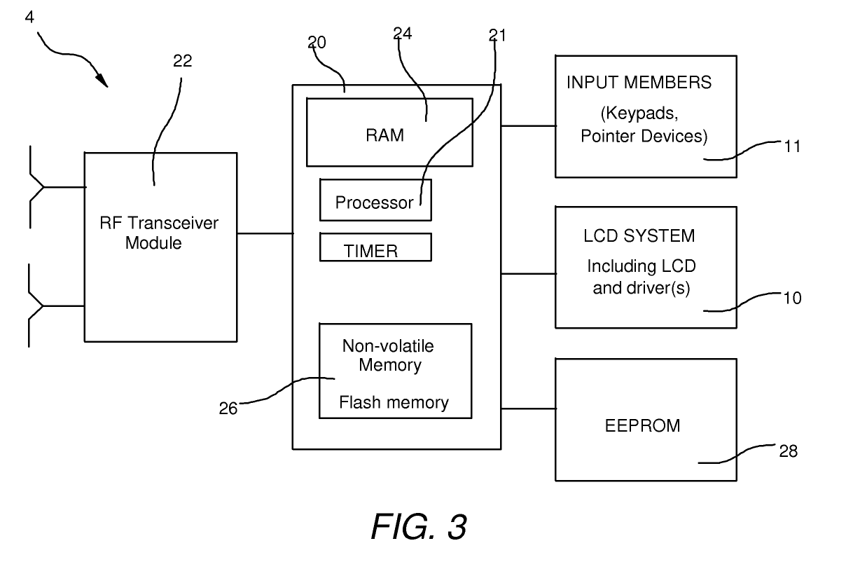

Various embodiments of the remote units 4 can be provided, including that illustrated as a simplified block diagram in FIG. 3, which can comprise a display (e.g., LCD) 10, input members 11, an RF transceiver module 22 and a microcontroller 20 having a processor 21, along with integral or peripheral RAM 24, writable non-volatile memory 26, such as flash memory, and programmable read only memory, such as, for example, EEPROM 28. In some embodiments of the present invention, the host unit 6 can have same or similar communications components as the remote units 4.

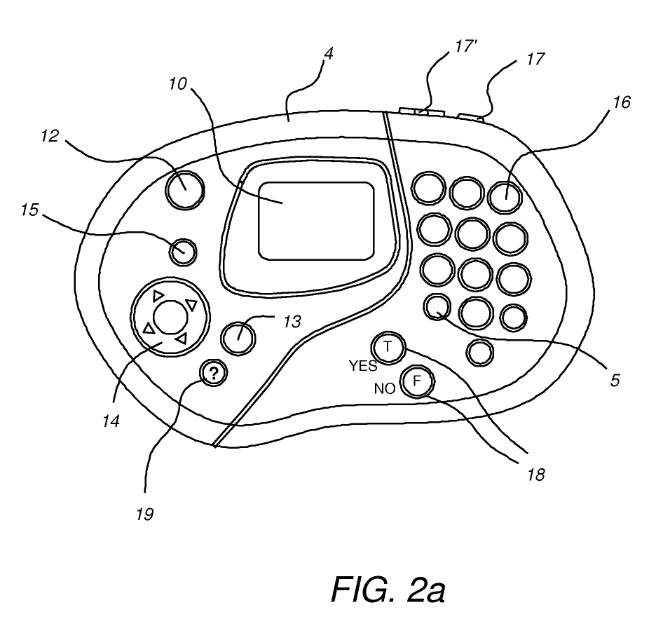

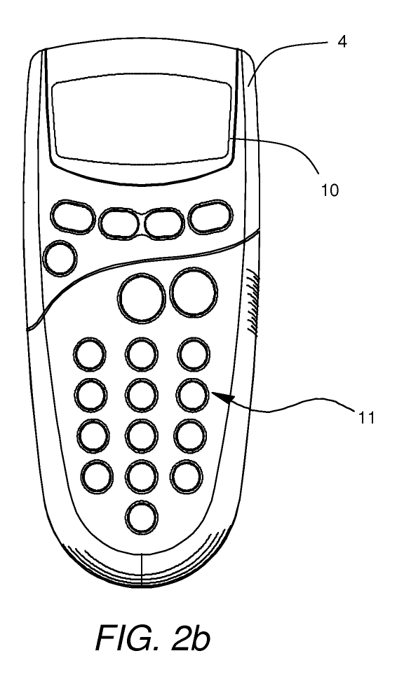

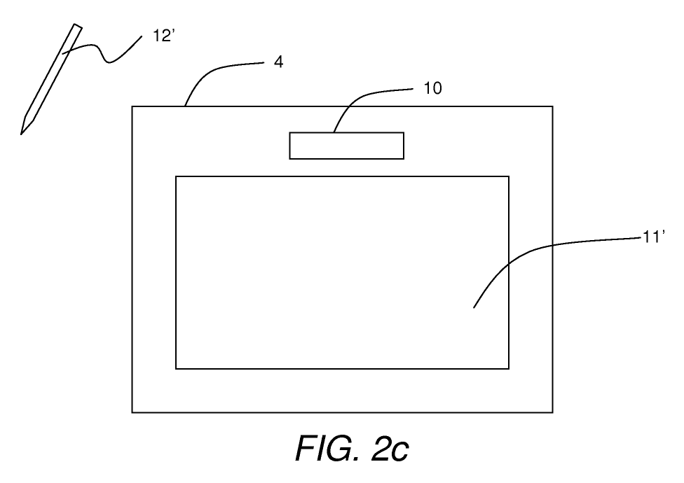

Referring to FIG. 2a, some embodiments of the remote units 4 have various manually operable input members 11 (labeled as keys 5, 12, 13, 14, 15, 16, 17, 17′, 18 and 19). The input members 11 can include a multidirectional cursor key 14 and an alphanumeric keypad 16. Some input members can be multifunctional, and configured to be operable in different modes to have more than one function, as will be appreciated by those skilled in the art after reviewing this disclosure. FIG. 2b shows another embodiment of a remote unit 4 usable with some embodiments of the present invention, having input members 11, and also a display 10, with an even more compact body. Furthermore, in some embodiments of the present invention, the input surface can include an active digitizer surface 11′, as shown in FIG. 2c, for sensing the proximity of a pointer pen 12′. In such embodiments, the remote unit 4 can have a display 10 and be provided with, or without, keys or keypads that are independent of the active digitizing surface 11′. In the remote unit 4, illustrated in FIG. 2c, no such independent keys or keypads are provided. Function or input locations serving like keys or keypads, can be assigned on the digitizing surface, which can be actuated using the pointer pen 12′, as will be appreciated by those skilled in the art after reviewing this disclosure. For example, all of the input member 11 functions disclosed above for the remote units illustrated in FIGS. 2a & 2b can be represented on the active digitizing surface 11′ so that a user can have access to the same functions on such active digitizing surface, except that the functions would be actuated by pointing at the assigned function location with the pen 12′, rather than pressing a button or key.

In the example embodiments for remote units 4 illustrated in FIGS. 2a, 2b, and 2c, it is notable that the remote unit 4 and display 10 may each need to be compact in order to remain portable and usable by a presenter while conducting a presentation and moving about a space. The display 10 dimensions may be, for example, without limitation, between six (6) square centimeters in surface area to forty (40) square centimeters in surface area. Also, the remote unit 4 may be, for example, without limitation, between forty (40) square centimeters to about one hundred and forty-four (144) square centimeters in total front surface area. In some embodiments, the display 10 can be an LCD display sized at approximately 120 pixels by 64 pixels, or be approximately one and one half (1 & ½) inches in width and three quarters (¾) of an inch in height. Other dimensions are contemplated; however, in some embodiments, compact dimensions at approximately 120 pixels by 64 pixels or smaller may contribute to the convenience for the presenter, which can be especially enhanced with the methods and systems for presentation of private presenter notes described herein.

In some embodiments of the present invention, a remote unit 4 is used by a presenter to initiate and control presentation media which includes a plurality of digital segments. The presentation media can be stored on a memory of computer 8, and during a presentation, the digital segments of the presentation media are projected using a projector 9 connected to computer 8, as best seen in FIG. 1. As will be appreciated by those skilled in the art after reviewing this disclosure, each digital segment can include, without limitation, a digital slide, or images, graphics, sound, animation, or information that is associated to a specific state of the presentation media (e.g. a digital slide having an associated audio and animation component). The presentation media can typically be controlled by toggling through digital segments using input members 11 of the presenter's remote unit 4, at the discretion of the presenter.

The remote unit 4 used by the presenter can be uniquely configured to allow access to control the presentation media, while audience remote units 4 are restricted, unless access is otherwise granted by the presenter. For example, control data transmitted by the presenter's remote unit 4 can be sent in connection with a unique remote unit 4 identifier recognized by a processor in the computer 8, which has in turn, been instructed to allow access by the unique presenter remote unit 4 to accept instructions from the presenter for controlling the presentation media.

In some embodiments of the present invention, the computer 8 is provided with instructions to associate private presenter notes with one or more digital segments. The private presenter notes may be preprogrammed by a presenter during preparation of the digital segments using computer 8 and presentation software. Thereafter, during presentation, as the presentation media is presented to an audience through projector 9, the private presenter notes can be transmitted from the host unit 6, to the presenter's remote unit 4 for display on a private display 10 thereof. The transmission may be private (avoiding view by audience members having remote units 4) by way of the host 6 transmitting a remote unit 4 identifier in connection with the private presenter notes. The identifier is uniquely recognized by the remote unit 4 used by a presenter, as will be appreciated by those skilled in the art after reviewing this disclosure.

Prophetic Example #1

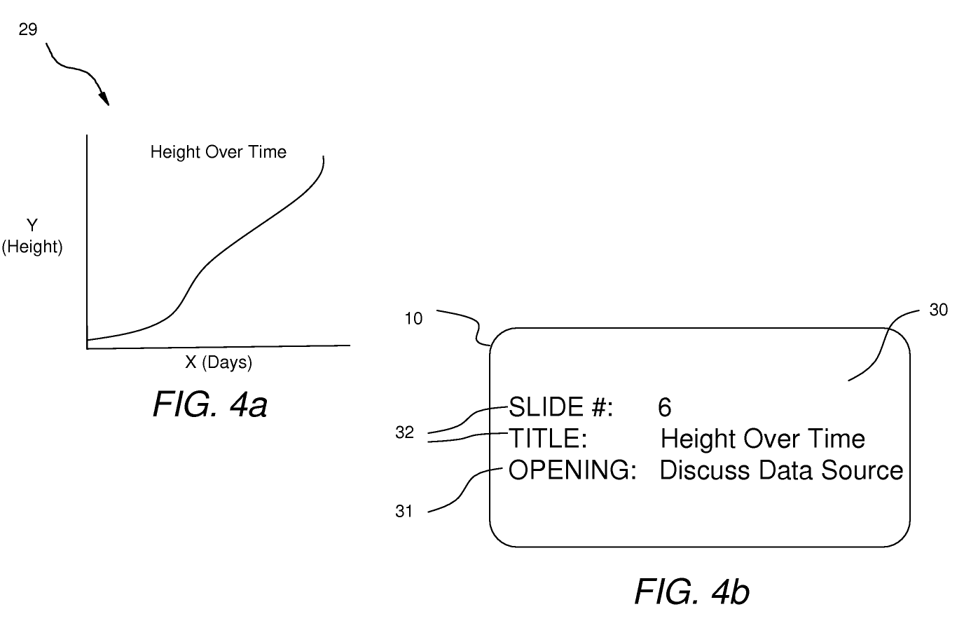

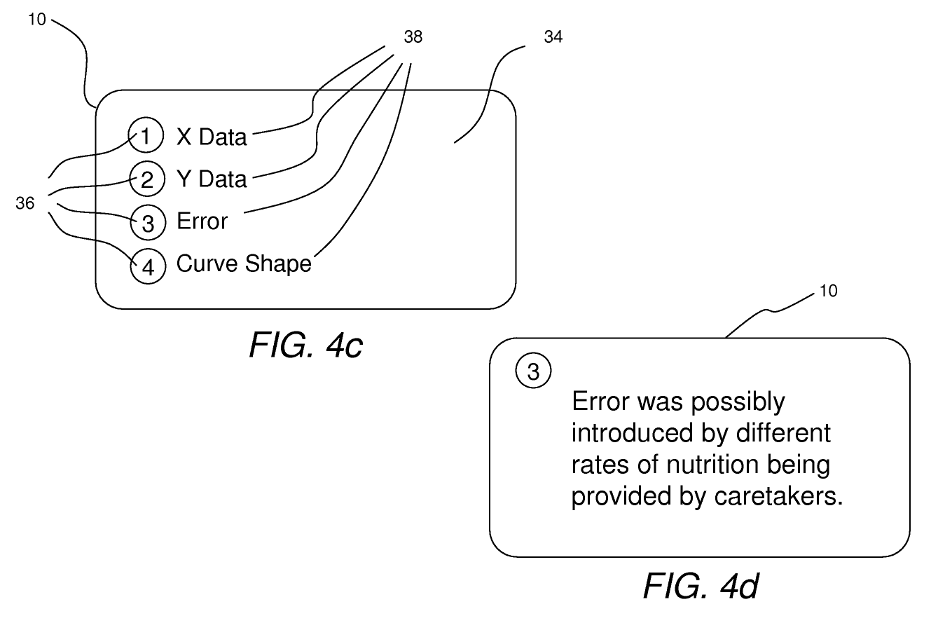

FIG. 4a is an example digital segment comprising a slide projected onto a screen viewable by audience members showing a graph entitled “Height Over Time.” Referring to FIG. 4b, in some embodiments of the present invention, the private presenter notes associated with the slide include a private slide header note 30 that is displayable on the display 10 of the presenter's remote unit 4. The private slide header 30 can include identifying information 32 for the digital segment, such as title and number. In FIG. 4b, the digital segment is identified as “SLIDE # 6” with the “TITLE” being “Height Over Time.” The private slide header 30 can also include an overview note 31 for the digital segment, which is illustrated in FIG. 4b as “OPENING: Discuss Data Source,” reminding the presenter to discuss where the data was obtained from for the graph being presented during this digital segment.

In some embodiments of the present invention, the input members 11, 11′ of the remote unit 4 include a designated “menu” key (not illustrated) that can be a manually depressable button, or a location on the active digitizing surface that can be actuated, to cause a note menu to be displayed for a current digital segment. In other embodiments, a note menu for a digital segment can be displayed by other actions, such as, for example, scrolling a cursor in a display 10 to select a menu function. As will be appreciated by those skilled in the art after reviewing this disclosure, a variety of manners for selecting a menu are contemplated using the various input members 11, 11′ disclosed above.

FIG. 4c shows a menu 34 for the digital segment associated with private slide header 30. The menu can be displayed within the private display 10 and can include different topics related to the current digital segment, which is associated with slide 29 in the present example. The menu 34 can include a topic list associated with the current slide 29, with an indicator proximate each topic. In FIG. 4c, the indicators 36 are numbers (1 through 4) and the topics 38 are “X Data,” “Y Data,” “Error” and “Curve Shape.” In the example embodiments, a presenter can press an input member 11, 11′ such as a key, or key location, corresponding to any one of the indicators 36 in the menu 34 to view a note on the display 10 for the topic. FIG. 4d shows a screen shot for the remote unit 4 display 10 for the present example when the presenter presses a key corresponding to the number “3,” which pulls up the “Errors” topic, and displays a more detailed note that encompasses a larger portion of the display 10 surface area that can help a presenter remember what to speak about in relation to the topic.

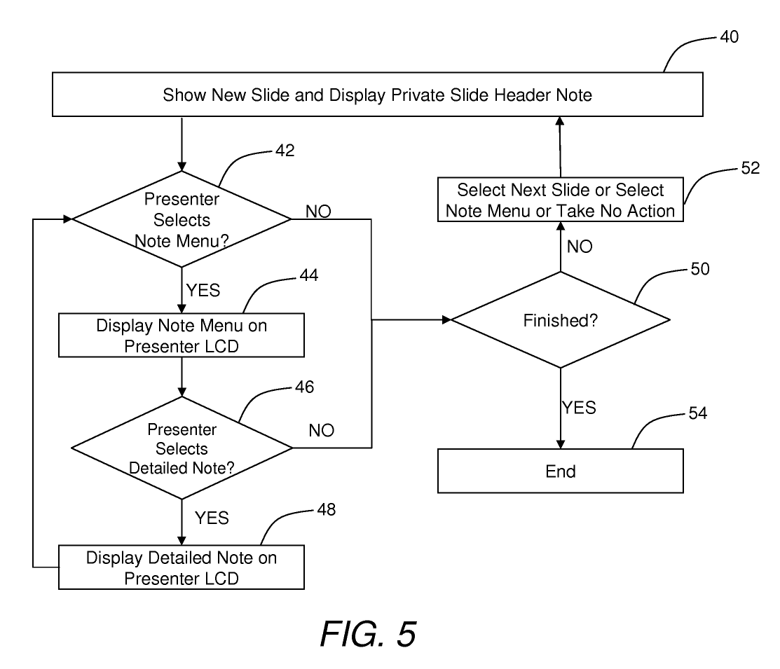

Example #1 above is provided for illustrative purposes. A method of displaying private presenter notes in a display screen of a presenter remote unit is also shown in FIG. 5. In a first step 40, when a slide is presented to an audience, a private slide header note 30 is displayed on the display 10 of a presenter's remote unit 4. The presenter can then select a note menu, in step 42. If the note menu is selected, it is displayed on the display 10. By viewing the note menu, the presenter can then select to view a detailed note, as shown in step 46. If the presenter selects to view a detailed note, using the note menu, the detailed note can then be displayed in the display 10, as shown in step 48.

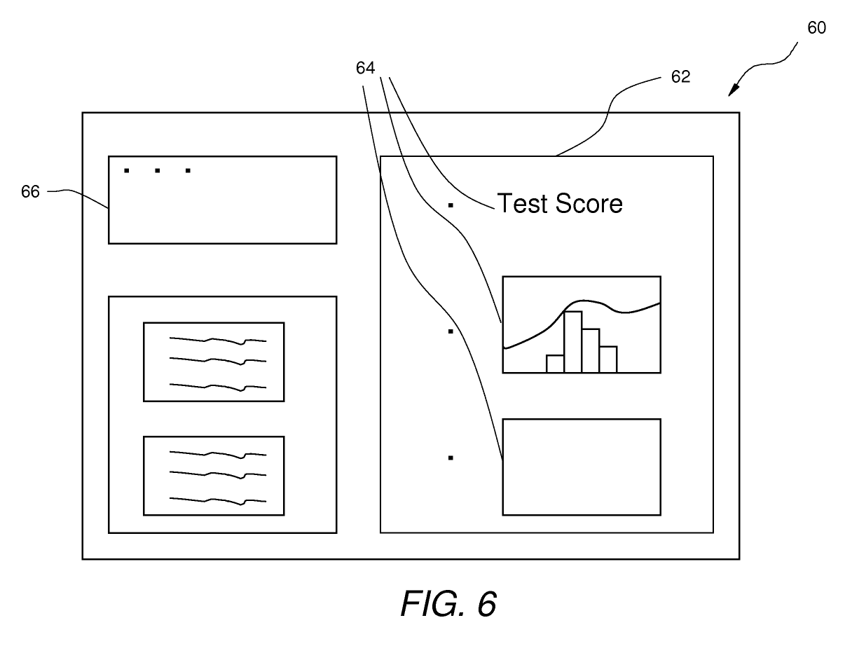

In some embodiments of the present invention, instructions are provided for the computer 8 for use in programming the private presenter notes. For example, a computer readable medium (e.g., floppy disks, CD-ROM disks, tapes, flash memory, system memory, DVD-ROM, or hard drives) can have code for instructing the computer 8 to display a graphical user interface for programming a presentation and associated private presenter notes. Referring to FIG. 6, in some embodiments of the present invention, when a presenter is preparing a slide presentation, a graphical user interface 60 is shown on a display of computer 8, having a slide preparation window 62. The slide preparation window 62 can show graphical fields 64 for text, images, animations, audio control, etc, as will be appreciated by those skilled in the art upon reviewing this disclosure. A note preparation window 66 can also be provided for use in programming the private presenter notes associated with each of the graphical fields 64, or other features of the presently viewable slide. A user can use a pointer device (such as a mouse) to select one or more of the graphical fields 64 then program a corresponding note in the note preparation window 66. The note can be displayed as an item in the menu 34 of FIG. 4c. Also, for each item of the menu, a user can use note preparation window 66 to program an associated detail note, such as, for example, the note 10 shown in FIG. 4d, as will be appreciated by those skilled in the art after reviewing this disclosure. Also, in some embodiments of the present invention, the user can program the slide header note 30 (shown in FIG. 4b) using the same note preparation window 66, to associate the slide header note 30 with an entire slide presently being programmed in the slide preparation window 66.

In some embodiments of the present invention, the audience response system 2 is used to collect audience response data during a presentation. The computer 8 can analyze the audience response data live as it is being received by the host 6. As such, in some embodiments of the present invention, the note preparation window 66 can be used to set private presenter notes that are displayable on remote unit 4 of the presenter as a function of audience feedback received during any particular digital segment. That is, for example, without limitation, if the presenter is a teacher, the teacher can pose a question to a student audience, and the computer 8 can cause a particular private presenter note, set of private presenter notes, or private presenter note menu, to be displayed to the teacher on the remote unit 4 held by the teacher, as a function of the feedback data received from student or audience remote units by the host unit 6 and computer 8. The function itself can be programmed by the teacher when programming the presentation. The private presenter note that is displayed can also be an instruction to the presenter or teacher to take a specific action as a result of the feedback received. For example, if the feedback received from an audience comprised of students indicates that a particular question has been answered incorrectly by a significant portion of students, a private presenter note can be shown to the teacher on the remote unit 4 instructing the teacher to review a particular chapter in a book with the audience. Also, for example, in some embodiments of the present invention, a user can select a feedback note mode using an input surface 11, 11′ of the remote unit 4. Once a presenter presents a new digital segment containing an inquiry, the presenter can select the feedback note mode and see notes that are displayable as a function of the feedback received from the audience members. The feedback notes can also comprise a primary or overview note (Example: “Too many incorrect answers by students for question #6. You should review lesson number 6 with them.”) and one or more note menus and detail notes that can be selectable using the display 10 and input members 11, 11′. Like the notes presented independently of student feedback as described above, the notes displayable as a result of student feedback can also comprise menus leading to selectable detailed notes. For example, once a user is in the feedback note mode, the user can select a menu that has a plurality of indicia associated with different notes related to different discussion topics regarding the feedback.

Prophetic Example #2

A presenter is conducting marketing research and displays a slide using the audience response system 2, the slide showing several optional colors for a new product. The presenter selects various private notes using the presenter remote 4 to aid the presenter in leading a discussion with the audience members viewing the colors. The slide contains an inquiry asking the audience members for their preference, and the audience members respond to the inquiry by transmitting feedback using remotes 4 in their possession. The presenter then selects a feedback note mode using the presenter remote 4 (which is configured to have access to the feedback notes and private presenter notes receivable through transmissions from computer 8). The presenter remote 4 then displays an overview note indicating that “The audience members favor the color red. Show shades of red to the audience.” The presenter can then select a feedback note menu, with the menu displaying indicia corresponding to notes regarding the different shades of red. The presenter selects a first note indicia after which the display 10 displays text reminding the presenter to discuss red colors of varying shades, and reminds the presenter to display particular slides.

When a new slide (or digital segment) is presented, the presenter can again select to see notes only associated with the digital segment being presented, rather than the feedback notes. Alternatively, in some embodiments, the display 10 can automatically display only notes that are not associated with audience feedback whenever a new digital segment (such as, for examples, a slide with a question) is presented, and the presenter must manually select the feedback note mode to view feedback notes.

Again, the examples illustrated above are not intended to be limiting and a variety of private presenter notes on different topics are contemplated herein as will be appreciated by those skilled in the art after reviewing the present disclosure.

An efficient system and method of delivering a presentation has been disclosed. In some embodiments, a more compact remote unit can be provided that can be held in a single hand with a relatively small display screen. In such embodiments, the presenter can use a single hand to hold the remote unit 4 and toggle through digital segments and associated slides, and to view notes by depressing keys, while being able to drill down on topics and view more detailed notes in a relatively compact display screen for each digital segment presented. All the while, the presenter notes can be private and the presenter can move freely about a space.

Another description of an audience response system is provided in published U.S. patent application No. 11/155,080, entitled “Systems and Methods for Selecting Audience Members,” published Dec. 21, 2006, which is incorporated herein by reference in its entirety.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices, systems and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A handheld presenter device comprising:
at least one input member;
a display screen;
a memory; and
a processing unit, wherein the processing unit is operable to receive signals from a remote system for displaying a first private presenter note in the display screen when a particular digital segment of a presentation is being displayed to an audience, the first private presenter note being pre-associated with the particular digital segment, and wherein at least one input member on the presenter device can be used to control digital segments being presented to an audience.

2. The handheld presenter device of claim 1 wherein the first private presenter note is a header note providing overview information about the particular digital segment and wherein the at least one input member can be actuated to display a note menu on the display screen for viewing a plurality of indicia, at least some of the indicia representing selectable detailed notes.

3. The handheld presenter device of claim 2 wherein at least one of the detailed notes can be selected and displayed on the display screen without displaying text related to another one of the detailed notes.

4. The handheld presenter device of claim 2 wherein the more detailed notes are selectable by pointing on an input member at position, or depressing a key, corresponding to an indicia associated with the more detailed note in the note menu.

5. The handheld presenter device of claim 1 wherein the display screen has dimensions that are equal to or less than 50 square centimeters.

6. The handheld presenter device of claim 1 wherein the display screen has a width of less than 3 inches and a height of less than 3 inches.

7. An audience response system comprising:
a host unit;
a plurality of remote units operable for use by audience members for wirelessly transmitting information to the host unit;
at least one audience display viewable by a plurality of audience members; and
a presenter remote unit having a private display, wherein the audience response system is configured to be capable of displaying private presenter notes on the private display that are associated with digital segments being displayed on the audience display.

8. The audience response system of claim 7 wherein the private presenter notes include a menu system for selecting a level of note detail displayed by the private display.

9. The audience response system of claim 8 wherein the menu system can display a plurality of indicia, each corresponding to a different note or a different note menu, wherein selecting an indicia corresponding to a note causes a note to be displayed in relation to a particular topic without displaying other notes, whereby space on the private display is conserved.

10. The audience response system of claim 7 wherein the presenter remote unit is configured to be usable to control digital segments being displayed on the audience display.

11. The audience response system of claim 10 wherein the presenter remote can also be used to select notes to view on the private display while the digital segments are being presented.

12. The audience response system of claim 11 wherein a plurality of different notes are selectable to view separately on the presenter remote during the presentation of a single digital segment.

13. The audience response system of claim 7 wherein an overview note is automatically displayed on the private display when a digital segment is initially displayed, and then a user can select to view a note menu to select additional notes.

14. The audience response system of claim 7 wherein a user can select a feedback mode on the presenter remote to view private notes that are generated as a function of audience feedback collected from audience remotes.

15. A method of presenting to an audience using a handheld presenter device having wireless communication capabilities, the method comprising:
selecting a digital segment to display using an input member on the handheld presenter device; and
selecting a private note to view on the handheld presenter device, the note being associated with the digital segment being displayed.

16. The method of claim 15 wherein selecting the private note comprises selecting a note menu to view, the note menu having a plurality of indicia, each associated with another note menu or a particular detailed note.

17. The method of claim 16 wherein if a detailed note is selected, it can be viewed separately from all other notes selectable for viewing.

18. The method of claim 16 further comprising displaying an overview note automatically when a digital segment is displayed.

19. The method of claim 16 wherein after a digital segment is presented, a user can select a feedback note mode using an input member on the presenter device to select a feedback note to display on the presenter device, the feedback note being a function of audience feedback.

20. The method of claim 19 wherein when the presenter selects the feedback note mode, a menu is provided to select a note from a plurality of notes generated as a function of audience feedback.
